(19) United States
(12) Patent Application Publication
(10) Pub. No.: US 2005/0010657 A1
(43) Pub. Date: Jan. 13, 2005

(54) Network system, data communication method, data communication program, and recording medium having the data communication stored thereon

(75) Inventors: Naoki Yamada, Tokyo (JP); Keiichi Sakai, Kanagawa (JP)

Correspondence Address: FITZPATRICK CELLA HARPER & SCINTO, 30 ROCKEFELLER PLAZA, NEW YORK, NY, 10112, US

(73) Assignee: CANON KABUSHIKI KAISHA, Tokyo (JP)

(21) Appl. No.: 10/852,158

(22) Filed: May 25, 2004

(30) Foreign Application Priority Data
Jun. 3, 2003 (JP) 2003-158531

(51) Int. Cl. G06F 15/173

(52) U.S. Cl. 709/223

(57) ABSTRACT

A network system including a server apparatus, and a client apparatus to be connected to the server apparatus, in which the client apparatus can store contents of operations on the client apparatus in a first storage circuit and send the stored contents of operations to the server apparatus, and the server apparatus can receive the contents of operations sent from the client apparatus and store the received contents of operations in a second storage circuit, and in which the client apparatus sends the contents of operations stored in the first storage circuit to the server apparatus in response to a logoff operation.

### BACKGROUND OF THE INVENTION

1. Field of the Invention

The present invention relates to, for example, a technique which is usable in a network system of a client/server model in which a client and servers are connected via a network such as an Intranet or a LAN.

2. Related Background Art

When a client operates electronic data (e.g., electronic data such as a medical image which requires protection of privacy) stored in a server via a network, it is important to record a log, which shows who logs on to the server, which data is accessed and downloaded, what kinds of operations are performed, and the like, in a log file and manage the log file surely.

In addition, a log file should never be corrected or falsified. Thus, it is desirable to transfer log files recorded in clients to a server and manage the log files collectively in the server to thereby prevent the log files from being falsified by a malicious client (user). Further, it is also desirable to make an arrangement such that an administrator can refer to the log files any time.

In order to realize this, conventionally, a log is generated every time a client (user) operates data stored in a server and the log is transferred to the server or, when a fixed time has elapsed, log files generated during the fixed time are transferred from the client to the server.

However, a large load is applied to a network with a low communication speed by generating a log every time a client operates data stored in a server and transferring the log to the server. The large load deteriorates response from the network to cause decline in operability on the client (server) side.

In addition, the method of transferring log files at a point when a fixed time has elapsed has a problem in that the log files are not transferred to a server if some failure (e.g., disconnection of a network) occurs until the time elapses, and the log files cannot be managed surely on the server side.

Those are very critical problems when a security function of a server is considered. For example, after a client (user) has logged on to the server and downloaded data, if the client interrupts a network intentionally, log files are not transferred to the server. Therefore, if the client repeats such a method, log files from this client are never transferred to the server.

### SUMMARY OF THE INVENTION

One aspect of the present invention is a network system including a server apparatus and a client apparatus to be connected to the server apparatus, in which: the client apparatus includes first storage means for storing contents of operations on the client apparatus and sending means for sending the contents of operations stored by the first storage means to the server apparatus; the server apparatus includes reception means for receiving the contents of operations sent by the sending means; and second storage means for storing the contents of operations received by the reception means; and the sending means sends the contents of operations stored by the first storage means to the server apparatus in response to a logoff operation of the client apparatus.

Other objects and features of the present invention will become apparent from the following description and the attached drawings.

### BRIEF DESCRIPTION OF THE DRAWINGS

FIG. 1 is a schematic diagram of a network system in accordance with an embodiment of the present invention;

FIG. 2 is a block diagram showing a functional structure of a client;

FIG. 3 is a block diagram showing a functional structure of a server;

FIG. 4 is a flowchart showing a flow of a series of processing in a first embodiment of the present invention; and

FIG. 5 is a flowchart showing a flow of a series of processing in a second embodiment of the present invention.

### DETAILED DESCRIPTION OF THE PREFERRED EMBODIMENTS

Preferred embodiments, to which the present invention is applied, will be hereinafter described in detail with reference to the accompanying drawings.

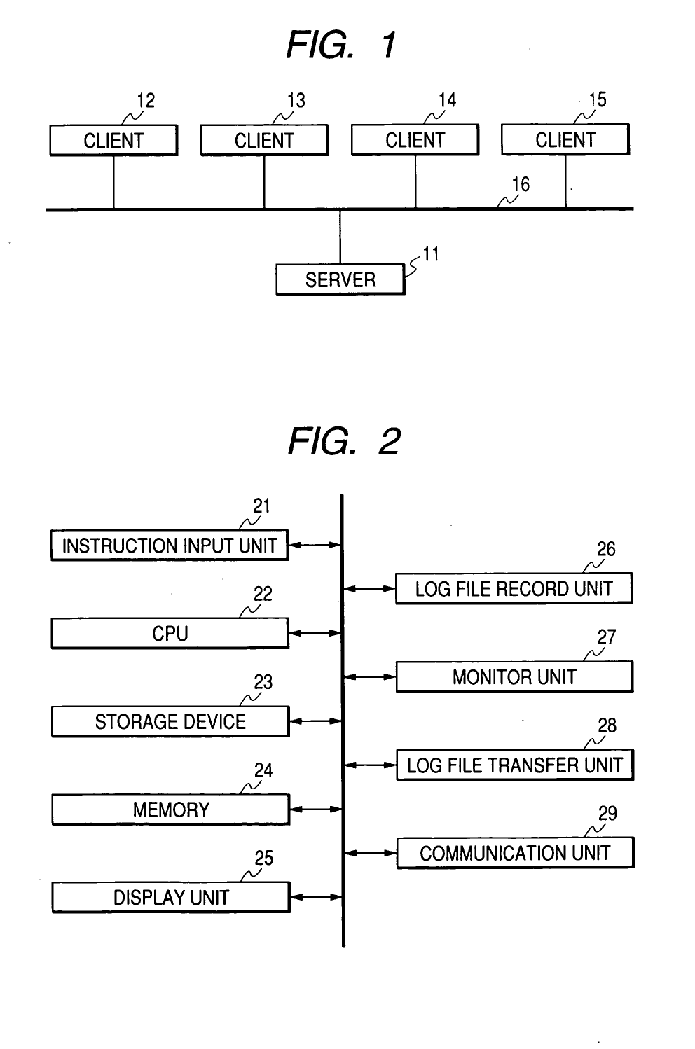

FIG. 1 is a schematic diagram of a network system in accordance with an embodiment of the present invention. In FIG. 1, reference numeral 11 denotes a server in which electronic data is stored, and 12 to 15 denote clients which perform operations such as browsing by downloading the data stored in the server 11 after accessing the server 11 via a network 16 and being authenticated to log on to the server 11.

The clients 12 to 15 are each provided with: a function for accessing and downloading the data stored in the server 11 and storing a record of operations as a log file; a function for monitoring alteration of a display screen and logoff from the server 11; and a function for transferring the log file stored in the clients 12 to 15 to the server 11.

In addition, the server 11 is provided with: a function for authenticating a client requesting connection to decide whether the client is allowed to make connection and access data; and a function for confirming whether log files transferred from the clients 12 to 15 have been completely received.

FIG. 2 is a block diagram showing a functional structure of the clients 12 to 15. In FIG. 2, reference numeral 21 denotes an instruction input unit which represents a general instruction input device such as a mouse or a keyboard; 22, a CPU which executes operations with respect to the data stored in the server 11 in accordance with an instruction from the instruction input unit 21; 23, a storage device for storing log files and the like; 24, a memory which temporarily stores data; and 25, a display unit which represents a general display device such as a liquid crystal display or a CRT display.

In addition, reference numeral 26 denotes a log file record unit which, when operations are executed with respect to the data stored in the server 11, records a history of the operations as a log file; 27, a monitor unit which monitors alteration of a display screen and logoff from the server 11; 28, a log file transfer unit which transfers the log file recorded by the log file record unit 26 to the server 11; and 29, a communication unit which accesses the server 11 and the other clients via the network 16 and communicates with the server 11 when the log file is transferred to the server 11.

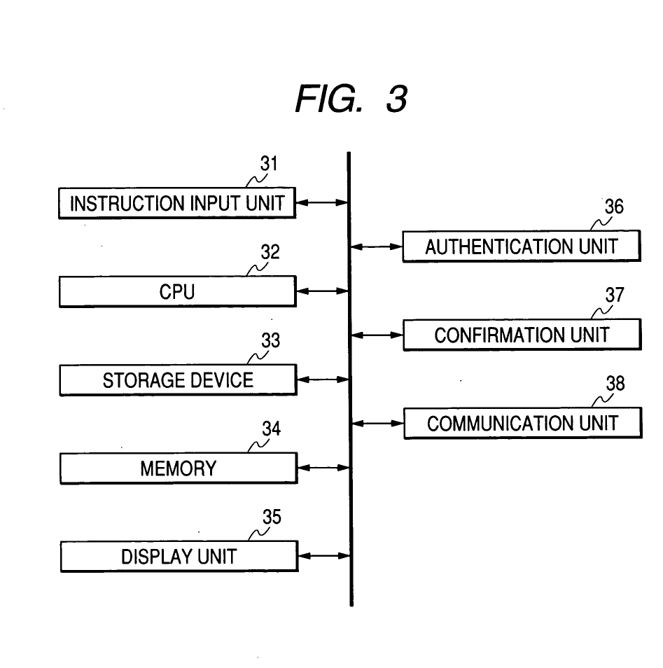

FIG. 3 is a block diagram showing a functional structure of the server 11 shown in FIG. 11. In FIG. 3, reference numeral 31 denotes an instruction input unit which represents a general instruction input device such as a mouse or a keyboard; 32, a CPU which performs various kinds of arithmetic operation processing; 33, a storage device which stores log files transferred from the clients 12 to 15; 34, a memory which temporarily stores data; and 35, a display unit which represents a general display device such as a liquid crystal display or a CRT display.

In addition, reference numeral 36 denotes an authentication unit which, when the clients 12 to 15 request connection, authenticates the clients to decide whether the clients are allowed to make connection and access data; 37, a confirmation unit for confirming whether log files transferred from the clients 12 to 15 have been completely received; and 38, a communication unit which accesses the clients 12 to 15 via the network 16 and communicates with the clients 12 to 15 when the log files are transferred from the clients.

When a client wishes to execute operations such as browsing and change with respect to the data stored in the server 11, the client instructs the communication unit 29 to request connection to the server 11 through the instruction input unit 21, and the communication unit 29 requests the communication unit 38 of the server 11 to make connection. When the server 11 confirms, through the communication unit 38, that the request for connection from the client is received, the server 11 authenticates the client using the authentication unit 36 to decide whether the client is allowed to make connection.

When the authentication is successful, after accessing and downloading the data stored in the server 11, the client can perform operations such as browsing and change through the display unit 25. It is the CPU 22 that actually executes operations. In addition, the log file record unit 26 records a history of the operations as a log file. The recorded log file is temporarily stored in the memory 24.

When a series of operations such as browsing and change end, the client alters the display screen or logs off from the server 11. The operation is monitored by the monitor unit 27. When the monitor unit 27 confirms that the operation is performed, the monitor unit 27 stores the log file, which is stored in the memory 24, in the storage device 23 and instructs the log file transfer unit 28 to transfer the log file to the server 11.

When the log file transfer unit 28 confirms the instruction from the monitor unit 27, the log file transfer unit 28 transfers the log file to the server 11 by using the communication unit 29. The confirmation unit 37 monitors the log file transferred from the communication unit 29. The confirmation unit 37 confirms whether the log file transferred from the client has been completely received by the communication unit 38 of the server 11. If the confirmation unit 37 judges that the log file could not be received completely, the confirmation unit 37 requests the client to transfer the log file again after a fixed time has elapsed or at the time of the next logon.

On the other hand, if the confirmation unit 37 judges that the log file could be completely received, the confirmation unit 37 notifies the client, which transferred the log file, that the log file have been received completely and causes the client to end the transfer. Then, the confirmation unit 37 stores the log file in the storage device 33 of the server. Consequently, it is possible to manage the log file in the server 11.

In addition, since the log file is transferred when the display screen of the client is altered, transfer processing is not performed frequently. Therefore, loads applied to the CPU and the network can be reduced. Moreover, it is possible to transfer the log file immediately after a series of operations such as browsing and change end by transferring the log file at the time of logoff. Therefore, the conventional problem in that a log file is not transferred to a server owing to a network failure or the like within a fixed time is also solved.

<First Embodiment>

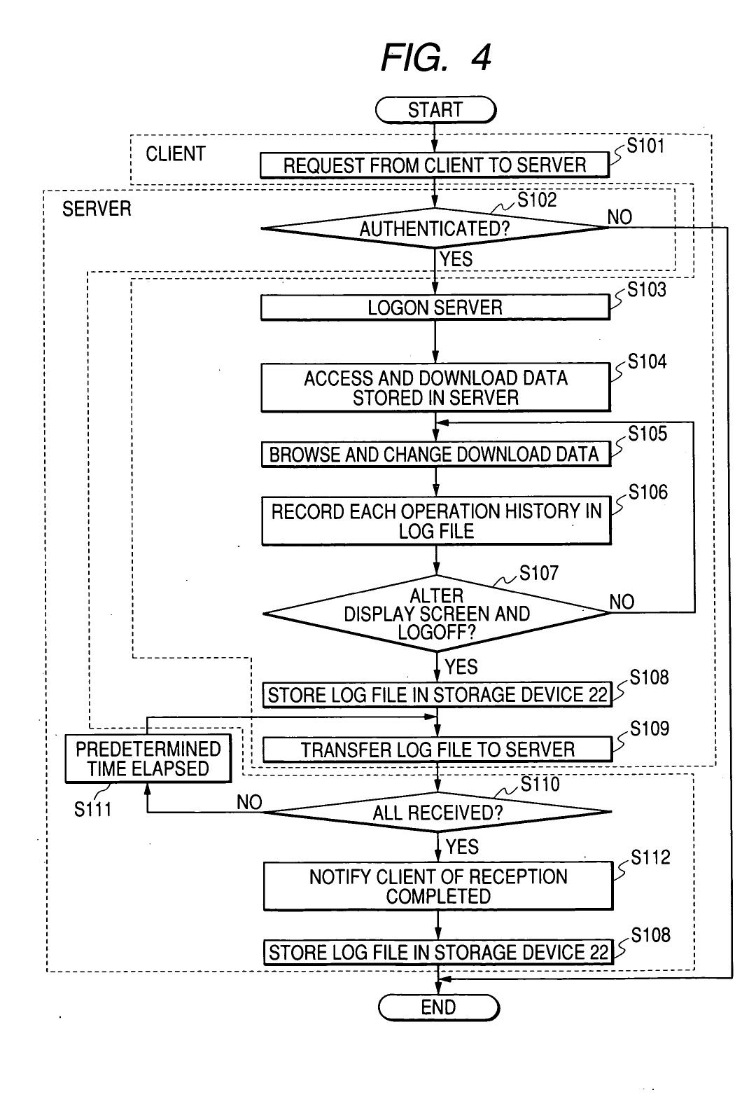

FIG. 4 is a flowchart showing a flow of a series of processing in a first embodiment of the present invention. When a request for connection is sent from the communication unit 29 of a client to the communication unit 38 of a server in step S101, authentication of the client is performed by the authentication unit 36 in step S102. If the authentication fails, the authentication unit 36 does not allow the client to log on to the server and ends the processing directly. If the authentication is successful, the client can proceed to step S103 and log on to the server.

The client, which has logged on to the server, can access or download data stored in the server (step S104) and perform operations such as browsing and change (step S105). Then, a history of the operations is recorded in a log file by the log file record unit 26 in step S106.

When the client ends the operations such as browsing and change, the client alters the display screen or logs off from the server in step S107. The monitor unit 27 monitors those operations. When those operations are executed, in step S108, the monitor unit 27 stores the log file in the storage device 23 and instructs the log file transfer unit 28 to transfer the log file to the server. When the log file transfer unit 28 confirms the instruction, the log file transfer unit 28 transfers the log file to the server (step S109).

The confirmation unit 37 of the server monitors the log file transferred from the client in step S110. If the log file could not be received completely, the server proceeds to step S111. In step S111, the server returns to S109 after a fixed time has elapsed, and causes the client to transfer the log file again. On this occasion, if the client has logged off or has shut down the machine, the server cannot cause the client to transfer the log file again after the fixed time has elapsed. Thus, the server causes the client to transfer the log file again at the time of the next logon.

In addition, if the log file could be received completely, the server notifies the client, which has transferred the log file, of completion of the reception in step S112, and ends the transfer. Then, the server stores the log file in the storage device 33 of the server in step S113. This makes it possible to transfer the log file surely and manage the log file in the server.

<Second Embodiment>

In the first embodiment, the authentication unit 36 is described as authenticating a connection request from the client. However, this is not necessarily the only function that the authentication unit 36 has. The authentication unit 36 also has a function for, if a log file at the time of the last logon of a client requesting connection has not been transferred to the server 11, not giving the client a right to access data stored in the server 11 even if the authentication is successful.

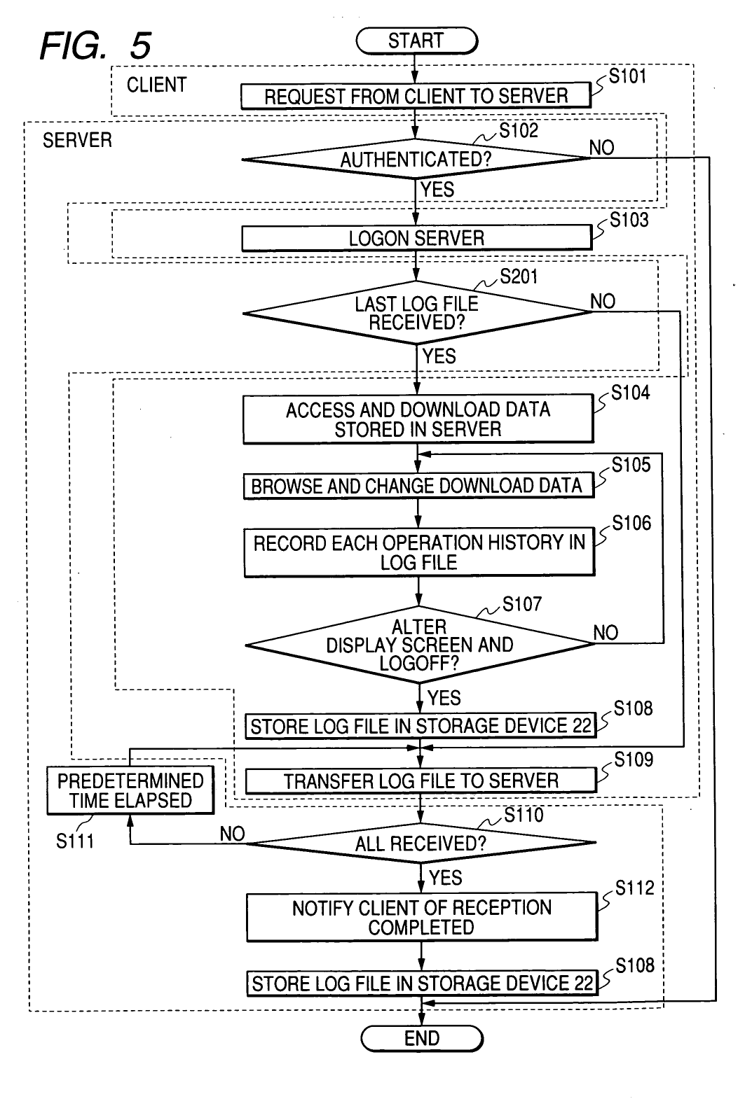

FIG. 5 is a flowchart showing a flow of a series of processing in a second embodiment of the present invention. Here, since the steps except step S201 are the same as those described in FIG. 4 of the first embodiment, the steps will not be described.

In step S201, the confirmation unit 37 judges whether a log file at the time of the last logon of the client, which logged on to the server, has been completely received in the server. If the log file has been received, the authentication unit 36 gives the client a right to access data. If the log file has not been received, the server requests the client to transfer the log file again, and the authentication unit 36 does not give the client a right to access data.

As described above, according to the embodiment, the conventional problem in that a client cannot transfer a log file owing to poor response, a network failure, or the like which is caused by a load on a network, and a server cannot manage a log file surely can be solved by transferring the log file to the server at the time of alteration of a display screen or at the time of logoff to prevent a large quantity of logs from being transferred to the server. Moreover, the problem in that a log file cannot be transferred owing to a network failure or the like, which has occurred within a fixed time, can also be solved.

In addition, it is possible to construct a network system provided with a higher security function by causing a client to transfer a log file again after a fixed time has elapsed or at the time of the next logon and by adding a function for, if a server could not receive a log file completely, not giving a client a right to access data even if the client is successful in logon next time.

In addition, the object of the present invention may be also attained by supplying a storage medium having stored thereon a program code for software for realizing the above-mentioned functions of the embodiments to a system or to an apparatus, and a computer (a CPU or an MPU) of the system or the apparatus reading out and executing the program code stored in the storage medium.

In this case, the program code itself read out from the storage medium realizes the above-mentioned functions of the embodiment. The program code itself and the storage medium having stored thereon the program code constitute the present invention.

Examples of an available storage medium for supplying the program code include a flexible disk, a hard disk, an optical disk, a magneto-optical disk, a CD-ROM, a CD-R, a magnetic tape, a nonvolatile memory card, and a ROM.

In addition, the present invention may include not only a case in which the above-mentioned functions of the embodiments are realized by a computer executing a read-out program code but also a case in which an OS (a basic system or an operating system) or the like running on the computer performs actual processing partly or entirely on the basis of an instruction of the program code, and the above-mentioned functions of the embodiments are realized by the processing.

Moreover, the present invention may also include a case in which, after a program code read out from a storage medium is written in a memory provided in a function extended board inserted in a computer or provided in a function extended unit connected to the computer, a CPU or the like provided in the function extended board or in the function extended unit performs actual processing partly or entirely on the basis of an instruction of the program code, and the above-mentioned functions of the embodiments are realized by the processing.

1. A network system comprising:
a server apparatus; and
a client apparatus to be connected to the server apparatus,
wherein the client apparatus can store contents of operations on the client apparatus in a first storage circuit and send the stored contents of operations to the server apparatus, and the server apparatus can receive the contents of operations sent from the client apparatus and store the received contents of operations in a second storage circuit, and
wherein the client apparatus sends the contents of operations stored in the first storage circuit to the server apparatus in response to a logoff operation.

2. A network system according to claim 1,
wherein the server apparatus judges whether the contents of operations sent by the client apparatus have been received completely, and if it is judged that the contents of operations have not been received completely, requests the client apparatus to send the contents of operations again.

3. A network system according to claim 1,
wherein the server apparatus judges whether the contents of operations sent by the client apparatus have been received completely, and if it is judged that the contents of operations have been received completely, notifies the client apparatus of completion of the reception.

4. A network system according to claim 2,
wherein the client apparatus sends the contents of operations stored in the first storage circuit again when the client apparatus logs on to the server apparatus next time.

5. A network system according to claim 4,
wherein the server apparatus further comprises limiting means which limits access from the client apparatus to the server apparatus until resending of the contents of operations by the client apparatus is completed.

6. A network system according to claim 2,
wherein the client apparatus sends the contents of operations stored in the first storage circuit again a predetermined time after the client apparatus receives a request for sending the contents of operations again from the server apparatus.

7. A network system comprising:
a server apparatus; and
a client apparatus to be connected to the server apparatus,
wherein the client apparatus can store contents of operations on the client apparatus in a first storage circuit and send the stored contents of operations to the server apparatus, and the server apparatus can receive the contents of operations sent from the client apparatus and store the received contents of operations in a second storage circuit, and
wherein the client apparatus sends the contents of operations stored in the first storage circuit to the server apparatus in response to an operation for altering a display screen of the client apparatus.

8. A network system according to claim 7,
wherein the server apparatus judges whether the contents of operations sent by the client apparatus have been received completely, and if it is judged that the contents of operations have not been received completely, requests the client apparatus to send the contents of operations again.

9. A network system according to claim 7,
wherein the server apparatus judges whether the contents of operations sent by the client apparatus have been received completely, and if it is judged that the contents of operations have been received completely, notifies the client apparatus of completion of the reception.

10. A network system according to claim 8,
wherein the client apparatus sends the contents of operations stored in the first storage circuit again when the client apparatus logs on to the server apparatus next time.

11. A network system according to claim 10,
wherein the server apparatus further comprises limiting means which limits access from the client apparatus to the server apparatus until resending of the contents of operations by the client apparatus is completed.

12. A network system according to claim 8,
wherein the client apparatus sends the contents of operations stored in the first storage circuit again when a predetermined time has elapsed after the client apparatus receives a request for sending the contents of operations again from the server apparatus.

13. A data communication method in a network system including a server apparatus and a client apparatus to be connected to the server apparatus, the data communication method comprising:
a first storage step of storing contents of operations on the client apparatus in the client apparatus;
a sending step of sending the contents of operations stored by the first storage step to the server apparatus;
a reception step of receiving the contents of operations sent in the sending step; and
a second storage step of storing the contents of operations received in the reception step in the server apparatus,
wherein the sending step sends the contents of operations stored by the first storage step to the server apparatus in response to a logoff operation of the client apparatus.

14. A data communication method according to claim 13,
wherein the reception step judges whether the contents of operations sent by the sending step have been received completely, and if it is judged that the contents of operations sent by the sending step have not been received completely, requests the client apparatus to send the contents of operations again.

15. A data communication method according to claim 13,
wherein the reception step judges whether the contents of operations sent by the sending step have been received completely, and if it is judged that the contents of operations sent by the sending step have been received completely, notifies the client apparatus of completion of the reception.

16. A data communication method according to claim 14,
wherein the sending step sends the contents of operations stored by the first storage step again at the time of a next logon.

17. A data communication method according to claim 16, further comprising a limiting step of limiting access from the client apparatus to the server apparatus until resending of the contents of operations by the sending step is completed.

18. A data communication method according to claim 14,
wherein the sending step sends the contents of operations stored by the first storage step again when a predetermined time has elapsed after the reception step judges that the contents of operations sent by the sending step have not been received completely.

19. A data communication method in a network system including a server apparatus and a client apparatus to be connected to the server apparatus, the data communication method comprising:
a first storage step of storing contents of operations on the client apparatus in the client apparatus;
a sending step of sending the contents of operations stored by the first storage step to the server apparatus;
a reception step of receiving the contents of operations sent in the sending step; and
a second storage step of storing the contents of operations received in the reception step in the server apparatus,
wherein the sending step sends the contents of operations stored by the first storage step to the server apparatus in response to an operation for altering a display screen of the client apparatus.

20. A data communication method according to claim 19,
wherein the reception step judges whether the contents of operations sent by the sending step have been received completely, and if it is judged that the contents of operations sent by the sending step have not been received completely, requests the client apparatus to send the contents of operations again.

21. A data communication method according to claim 19,
wherein the reception step judges whether the contents of operations sent by the sending step have been received completely, and if it is judged that the contents of operations sent by the sending step have been received completely, notifies the client apparatus of completion of the reception.

22. A data communication method according to claim 20,
wherein the sending step sends the contents of operations stored by the first storage step again at the time of a next logon.

23. A data communication method according to claim 22, further comprising a limiting step of limiting access from the client apparatus to the server apparatus until resending of the contents of operations by the sending step is completed.

24. A data communication method according to claim 20,
wherein the sending step sends the contents of operations stored by the first storage step again when a predetermined time has elapsed after the reception step judges that the contents of operations sent by the sending step have not been received completely.

25. A data communication program in a network system including a server apparatus and a client apparatus to be connected to the server apparatus, the data communication program comprising:
a first storage step of storing contents of operations on the client apparatus in the client apparatus;
a sending step of sending the contents of operations stored by the first storage step to the server apparatus;
a reception step of receiving the contents of operations sent in the sending step; and
a second storage step of storing the contents of operations received in the reception step in the server apparatus,
wherein the sending step sends the contents of operations stored by the first storage step to the server apparatus in response to a logoff operation of the client apparatus.

26. A data communication program in a network system including a server apparatus and a client apparatus to be connected to the server apparatus, the data communication program comprising:
a first storage step of storing contents of operations on the client apparatus in the client apparatus;
a sending step of sending the contents of operations stored by the first storage step to the server apparatus;
a reception step of receiving the contents of operations sent in the sending step; and
a second storage step of storing the contents of operations received in the reception step in the server apparatus,
wherein the-sending step sends the contents of operations stored by the first storage step to the server apparatus in response to an operation for altering a display screen of the client apparatus.

27. A computer readable recording medium having stored thereon a data communication program in a network system including a server apparatus and a client apparatus to be connected to the server apparatus, the computer readable recording medium comprising:
a first storage step of storing contents of operations on the client apparatus in the client apparatus;
a sending step of sending the contents of operations stored by the first storage step to the server apparatus;
a reception step of receiving the contents of operations sent in the sending step; and
a second storage step of storing the contents of operations received in the reception step in the server apparatus,
wherein the sending step sends the contents of operations stored by the first storage step to the server apparatus in response to a logoff operation of the client apparatus.

28. A computer readable recording medium having stored thereon a data communication program in a network system including a server apparatus and a client apparatus to be connected to the server apparatus, the computer readable recording medium comprising:
a first storage step of storing contents of operations on the client apparatus in the client apparatus;
a sending step of sending the contents of operations stored by the first storage step to the server apparatus;
a reception step of receiving the contents of operations sent in the sending step; and
a second storage step of storing the contents of operations received in the reception step in the server apparatus,
wherein the sending step sends the contents of operations stored by the first storage step to the server apparatus in response to an operation for altering a display screen of the client apparatus.
